(19) United States
(12) Patent Application Publication
(10) Pub. No.: US 2026/0274134 A1
(43) Pub. Date: Sep. 17, 2026

(54) VEHICLE SEAT

(71) Applicants: NHK SPRING CO., LTD., Yokohama-shi (JP); SUBARU CORPORATION, Tokyo (JP)

(72) Inventors: Kousuke SUZUKI, Yokohama-shi (JP); Chikanori HONDA, Yokohama-shi (JP); Donghyoun KIM, Yokohama-shi (JP); Katsutoshi IMANARI, Yokohama-shi (JP); Atsuhiro TOMINAGA, Tokyo (JP)

(21) Appl. No.: 19/565,748

(22) Filed: Mar. 13, 2026

(30) Foreign Application Priority Data
Mar. 14, 2025 (JP) 2025-041925

(51) Int. Cl. B60N 2/806; B60N 2/00

(52) U.S. Cl. CPC B60N 2/806; B60N 2/0022

(57) ABSTRACT

A vehicle seat, includes: a seat cushion that is configured to support the buttocks of a seated occupant; a seatback that is supported tiltably downward toward a seat front side relative to the seat cushion; and a headrest configured to adopt a first state, in which the headrest is disposed at a seat upper side of the seatback and is configured to support the head of the seated occupant in a state in which the seatback is upright relative to the seat cushion, and a second state, in which the headrest is disposed at a portion at a seat front side of a support surface at the seat upper side of the seatback and the headrest is configured to support the head of the occupant lying on the support surface in a state in which the seatback is tilted downward toward the seat front side.

### CROSS-REFERENCE TO RELATED APPLICATION

This application claims priority under 35 USC 119 from Japanese Patent Application No. 2025-041925 filed on Mar. 14, 2025, the disclosure of which is incorporated by reference herein in its entirety.

### BACKGROUND

### Technical Field

This disclosure relates to a vehicle seat.

### Related Art

Japanese Patent Application Laid-open (JP-A) No. 2015-199459 discloses an invention relating to a vehicle seat. In this vehicle seat, the headrest can be tilted downward in a range from a support position, in which it can support the heat of an occupant, to a tilted down position.

Furthermore, the vehicle seat has a tilt angle adjustment device which, when the seatback is tilted downward toward the seat front side while the headrest is positioned in the forwardly tilted position, allows the headrest to be pivoted to the support position. For this reason, in this vehicle seat, the tilt down of the seatback can be inhibited from being hindered by the headrest coming into contact with the seat cushion.

### SUMMARY

In this connection, in recent years there has been an increase in the number of people who use vehicle seats as beds and for other purposes to go car camping.

In this respect, although JP-A No. 2015-199459 facilitates the use of the vehicle seat as a bed and for other purposes by making it easier to tilt down the seatback, the headrest is unable to be utilized to improve the environment for car camping. That is, the technology of JP-A No. 2015-199459 has room for improvement from the standpoint of improving the sleeping environment when sleeping on the vehicle seat.

In view of the above circumstances, this disclosure obtains a vehicle seat that can improve the sleeping environment when sleeping on the vehicle seat.

A vehicle seat pertaining to a first aspect includes: a seat cushion that is configured to support the buttocks of a seated occupant; a seatback that is supported tiltably downward toward a seat front side relative to the seat cushion; and a headrest configured to adopt a first state, in which the headrest is disposed at a seat upper side of the seatback and is configured to support the head of the seated occupant in a state in which the seatback is upright relative to the seat cushion, and a second state, in which the headrest is disposed at a portion at a seat front side of a support surface at the seat upper side of the seatback and the headrest is configured to support the head of the occupant lying on the support surface in a state in which the seatback is tilted downward toward the seat front side.

According to the vehicle seat pertaining to the first aspect, the seatback is supported tiltably downward toward a seat front side relative to the seat cushion. For this reason, in a state in which the seatback is upright relative to the seat cushion, the buttocks of the seated occupant can be supported by the seat cushion and the back of the occupant can be supported by the seatback.

In a state in which the seatback is tilted downward toward the seat front side relative to the seat cushion, the occupant lying on the seatback can be supported by the support surface at the seat upper side of the seatback.

Here, in this aspect, the headrest that can take the first state, in which the headrest is disposed at the seat upper side of the seatback in a state in which the seatback is upright relative to the seat cushion, and the second state, in which the headrest is disposed at the seat front part of the support surface at the seat upper side of the seatback in a state in which the seatback is tilted downward toward the seat front side.

For this reason, in the first state, the headrest can support the head of the seated occupant. Furthermore, in the second state, the headrest can support the head of the occupant lying on the support surface of the seatback. In other words, in this aspect, the headrest in the second state can be utilized as a pillow for the occupant lying on the seatback.

A vehicle seat pertaining to a second aspect is the vehicle seat pertaining to the first aspect, in which a headrest stay extends from the headrest, and the seatback is provided with a first headrest support that supports the headrest stay in the first state and a second headrest support that supports the headrest stay in the second state.

According to the vehicle seat pertaining to the second aspect, the headrest stay extends from the headrest. The seatback is provided with the first headrest support and the second headrest support.

In the first state of the headrest, the headrest stay is supported by the first headrest support, and in the second state of the headrest, the headrest stay is supported by the second headrest support.

For this reason, in this aspect, the position of the first headrest support and the second headrest support can be individually set, and flexibility for the set position of the headrest in the first state and the set position of the headrest in the second state can be ensured.

A vehicle seat pertaining to a third aspect is the vehicle seat pertaining to the first aspect, in which a headrest stay extends from the headrest, and the seatback includes a headrest support that supports the headrest stay and is supported pivotably about an axis in the seat width direction relative to the seatback.

According to the vehicle seat pertaining to the third aspect, the headrest stay extends from the headrest. The seatback is provided with the headrest support that supports the headrest stay, and the headrest support is supported pivotably about an axis in a seat width direction relative to the seatback.

For this reason, in this aspect, the headrest can be switched between the first state and the second state by pivoting the headrest support relative to the seatback.

A vehicle seat pertaining to a fourth aspect is the vehicle seat pertaining to the first aspect, in which a headrest stay configured to support the headrest extends from the seatback, and the headrest is supported pivotably about an axis in a seat width direction relative to the headrest stay.

According to the vehicle seat pertaining to the fourth aspect, the headrest stay extends from the seatback, and the headrest is supported pivotably about an axis in the seat width direction relative to the headrest stay.

For this reason, in this aspect, the headrest can be switched between the first state and the second state by pivoting the headrest relative to the headrest stay.

A vehicle seat pertaining to a fifth aspect is the vehicle seat pertaining to any one of the second aspect to the fourth aspect, in which the headrest is displaceable relative to the seatback such that a surface of the headrest that is at the seat upper side in the first state is at the seat upper side in the second state, and a sleep state detection sensor configured to detect a sleep state of the occupant is provided at the surface of the headrest.

According to the vehicle seat pertaining to the fifth aspect, the surface that is at the seat upper side in the first state of the headrest is at the seat upper side in the second state of the headrest. For this reason, the surfaces that support the head of the occupant in the first state of the headrest and the second state of the headrest can be made different.

As a result, the surface that supports the head of the occupant in the first state of the headrest can be given a shape suitable for supporting the head of the seated occupant, and the surface that supports the head of the occupant in the second state of the headrest can be given a shape suitable for supporting the head of the occupant lying on the seatback.

Furthermore, in this aspect, the sleep state detection sensor is provided at the surface that supports the head of the occupant in the second state of the headrest, and the sleep state of the occupant lying on the seatback can be detected.

A vehicle seat pertaining to a sixth aspect is the vehicle seat pertaining to the third aspect, in which the headrest is supported pivotably about an axis in the seat width direction relative to the headrest stay such that a surface of the headrest that is at the seat rear side in the first state is at the seat upper side in the second state, and a sleep state detection sensor configured to detect a sleep state of the occupant is provided at the surface of the headrest.

According to the vehicle seat pertaining to the sixth aspect, the headrest pivots about an axis in the seat width direction relative to the headrest stay, and the surface that is at the seat rear side in the first state of the headrest is at the seat upper side in the second state of the headrest. For this reason, the surfaces that support the head of the occupant in the first state of the headrest and the second state of the headrest can be made different.

As a result, the surface that supports the head of the occupant in the first state of the headrest can be given a shape suitable for supporting the head of the seated occupant, and the surface that supports the head of the occupant in the second state of the headrest can be given a shape suitable for supporting the head of the occupant lying on the seatback.

Furthermore, compared with a configuration where the surface that supports the head of the occupant in the second state of the headrest is positioned at the seat upper side in the first state of the headrest, the headrest can be inhibited from increasing in size, and areas for the surfaces that support the head of the occupant in the first state of the headrest and the second state of the headrest can be ensured.

Moreover, in this aspect, the sleep state detection sensor is provided at the surface that supports the head of the occupant in the second state of the headrest, and the sleep state of the occupant lying on the seatback can be detected.

A vehicle seat pertaining to a seventh aspect is the vehicle seat pertaining to the third aspect, in which the headrest is supported pivotably about an axis in the seat width direction relative to the headrest stay such that a surface of the headrest that is at the seat front side in the first state is at the seat upper side in the second state, and a sleep state detection sensor configured to detect a sleep state of the occupant is provided at the surface of the headrest.

According to the vehicle seat pertaining to the seventh aspect, the headrest pivots about an axis in the seat width direction relative to the headrest stay, and the surface that is at the seat front side in the first state of the headrest is at the seat upper side in the second state. The sleep state detection sensor is provided at this surface, and in this aspect, the sleep state of the occupant can be detected when the occupant is seated and when the occupant is lying on the seatback.

As described above, the vehicle seat pertaining to this disclosure has the superior effect that it can improve the sleeping environment when the occupant sleeps on the vehicle seat in a state in which the seatback is tilted downward toward the seat front side .

### BRIEF DESCRIPTION OF THE DRAWINGS

FIG. 1 is a side view schematically showing a vehicle seat pertaining to a first embodiment and vehicle configurations around the vehicle seat;

FIG. 2A is a front view schematically showing the configuration of a headrest of the vehicle seat pertaining to the first embodiment;

FIG. 2B is a side view schematically showing the configuration of the headrest of the vehicle seat pertaining to the first embodiment;

FIG. 3A is a side view schematically showing a process in which the vehicle seat pertaining to the first embodiment is transformed from a seat mode to a flat mode and shows the vehicle seat in the seat mode;

FIG. 3B is a side view schematically showing the process in which the vehicle seat pertaining to the first embodiment is transformed from the seat mode to the flat mode and shows the vehicle seat in a forwardly tilted down state;

FIG. 3C is a side view schematically showing the process in which the vehicle seat pertaining to the first embodiment is transformed from the seat mode to the flat mode and shows the vehicle seat in the flat mode;

FIG. 4 is a plan view schematically showing the configuration of a cabin when the vehicle seat pertaining to the first embodiment is in the flat mode;

FIG. 5 is a block diagram schematically showing the relationship between various types of sensors provided in the vehicle seat pertaining to the first embodiment and various types of devices installed in the vehicle;

FIG. 6A is a side view schematically showing a process in which a vehicle seat pertaining to a second embodiment is transformed from the seat mode to the flat mode and shows a first state;

FIG. 6B is a side view schematically showing the process in which the vehicle seat pertaining to the second embodiment is transformed from the seat mode to the flat mode and shows a second state;

FIG. 6C is a side view schematically showing the process in which the vehicle seat pertaining to the second embodiment is transformed from the seat mode to the flat mode and shows a third state;

FIG. 7A is a side view schematically showing a process in which a vehicle seat pertaining to a third embodiment is transformed from the seat mode to the flat mode and shows the vehicle seat in the seat mode;

FIG. 7B is a side view schematically showing the process in which the vehicle seat pertaining to the third embodiment is transformed from the seat mode to the flat mode and shows the vehicle seat being forwardly tilted down;

FIG. 7C is a side view schematically showing the process in which the vehicle seat pertaining to the third embodiment is transformed from the seat mode to the flat mode and shows the vehicle seat in the flat mode;

FIG. 8A is a side view schematically showing a process in which a vehicle seat pertaining to an example modification of the third embodiment is transformed from the seat mode to the flat mode and shows the vehicle seat in the seat mode;

FIG. 8B is a side view schematically showing the process in which the vehicle seat pertaining to the example modification of the third embodiment is transformed from the seat mode to the flat mode and shows the vehicle seat being forwardly tilted down;

FIG. 8C is a side view schematically showing the process in which the vehicle seat pertaining to the example modification of the third embodiment is transformed from the seat mode to the flat mode and shows the vehicle seat in the flat mode;

FIG. 9A is a side view schematically showing the headrest of a vehicle seat pertaining to a fourth embodiment and shows the headrest in the seat mode; and

FIG. 9B is a side view schematically showing the headrest of the vehicle seat pertaining to the fourth embodiment and shows the headrest in the flat mode.

### DETAILED DESCRIPTION

### First Embodiment

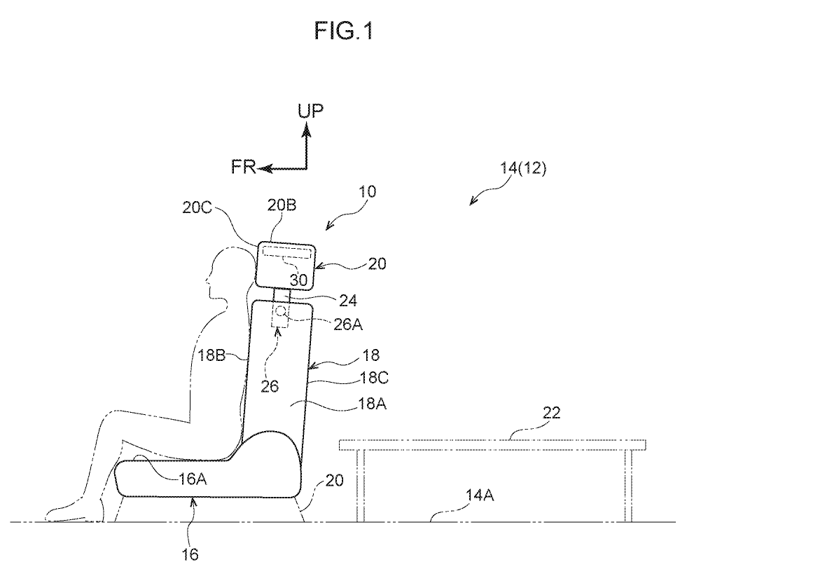

A first embodiment of the vehicle seat pertaining to this disclosure will be described below using FIGS. 1-5. It will be noted that arrow FR, arrow UP, and arrow RH shown as appropriate in the drawings indicate a forward direction, an upward direction, and a rightward direction, respectively, of a vehicle seat 10 (hereinafter called “the seat 10”) pertaining to this embodiment. Furthermore, the forward direction of the seat 10 coincides with the forward direction of a vehicle 12 in which the seat 10 is installed, the upward direction of the seat 10 coincides with the upward direction of the vehicle 12, and the rightward direction of the seat 10 coincides with the rightward direction of the vehicle 12.

As shown in FIG. 1, the seat 10 is a rear seat disposed in a cabin 14 of the vehicle 12 and includes a seat cushion 16 that supports the buttocks and thighs of an occupant P, a seatback 18 that supports the back of the occupant P, and a headrest 20 that supports the head of the occupant P.

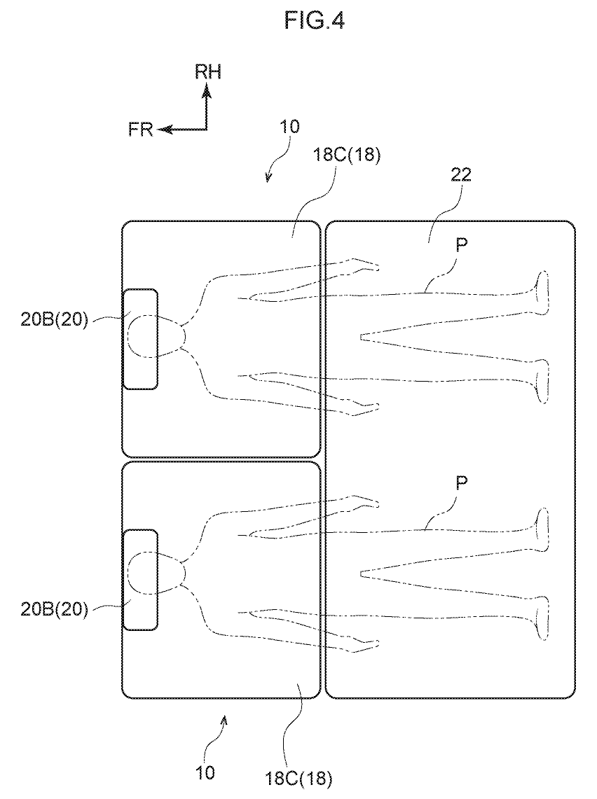

The seat cushion 16 is configured to includes a cushion pad (not shown in the drawings), which configures the main part of the seat cushion 16 and is configured by polyurethane foam, and a cushion cover 16A, which covers the cushion pad. As shown also in FIG. 4, the seat cushion 16 has a rectangular shape whose lengthwise direction coincides with the seat width direction as viewed from the seat up and down direction. It will be noted that the seat cushion 16 is installed via a seat base 21 on a floor 14A of the cabin 14 and is slidable in the seat forward and rearward direction relative to the seat base 21.

The seatback 18 includes a seatback pad (not shown in the drawings), which configures the main part of the seatback 18 and is configured by urethane foam, and a seatback cover 18A, which covers the seatback pad.

Specifically, the seatback 18 overall has a cuboidal shape whose lengthwise direction coincides with the seat up and down direction in a state in which the occupant P is sitting in the seat 10, and the seat front surface thereof is a support surface 18B that supports the back of the occupant P.

The seatback 18 is coupled via a reclining mechanism (not shown in the drawings) to the seat rear part of the seat cushion 16 and is tiltable in the seat forward and rearward direction relative to the seat cushion 16.

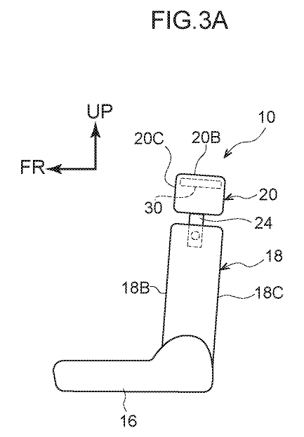

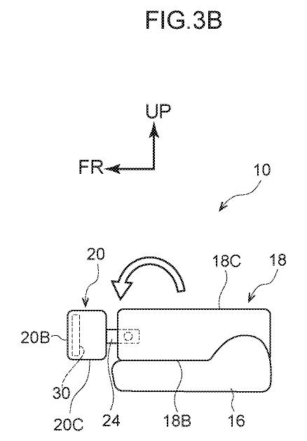

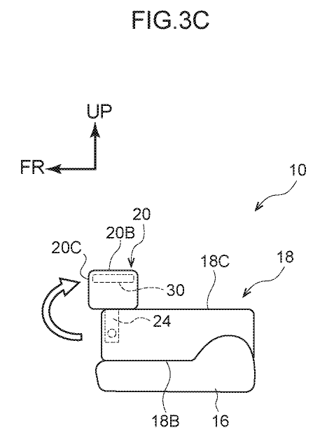

Furthermore, in a state in which the seatback 18 is most forwardly tilted relative to the seat cushion 16 (see FIGS. 3B and 3C), a support surface 18C of the seatback 18 on the opposite side of the support surface 18B is substantially horizontal. It will be noted that, in what follows, a state in which the seatback 18 is upright relative to the seat cushion 16 and in which the occupant P can sit in the seat 10 will be called a seat mode of the seat 10, and a state in which the seatback 18 is most forwardly tilted relative to the seat cushion 16 will be called a flat mode.

Furthermore, in this embodiment, as shown also in FIG. 4, a deck board 22, which is configured in the shape of a rectangular board whose thickness direction coincides with the vehicle up and down direction and whose lengthwise direction coincides with the vehicle width direction when viewed from the vehicle up and down direction, is disposed on the vehicle rear side of the seat 10 in the cabin 14. The deck board 22 can configure a bed together with the seat 10 in the flat mode, and in this state the occupant P can lie on the support surface 18C of the seatback 18. It will be noted that instead of the deck board 22, a seat having the same configuration as the seat 10 but not including the headrest 20 may be disposed on the vehicle rear side of the seat 10 such that a bed is configured by the seat and the seat 10.

Here, this embodiment is characterized in that the headrest 20 can support the head of the occupant P who is on the support surface 18C when the seat 10 is in the flat mode. The configuration of the headrest 20 will be described in detail below. It will be noted that, in what follows, unless otherwise specified, description will proceed on the assumption that the seat 10 is in the seat mode.

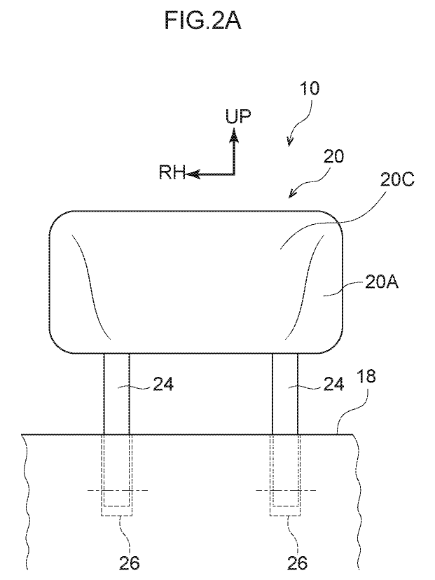

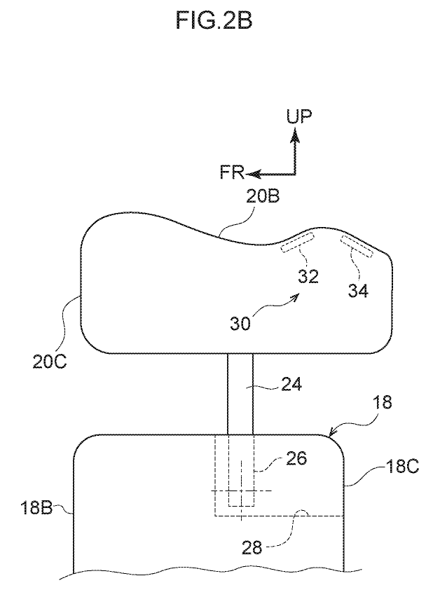

As shown in FIG. 2A, the headrest 20 is configured to include a headrest body (not shown in the drawings), which configures the main part of the headrest 20 and is configured by polyurethane foam and is used to support the head of the occupant P, and a headrest cover 20A, which covers the headrest body. A pair of headrest stays 24 spaced apart from each other in the seat width direction extend in the seat downward direction from the headrest 20.

It will be noted that the headrest 20 overall has a cuboidal shape whose lengthwise direction coincides with the seat width direction as viewed from the seat up and down direction and whose lengthwise direction coincides with the seat forward and rearward direction as viewed from the seat width direction.

The headrest stays 24 are supported by headrest supports 26 provided in the seat upper part of the seatback 18. As shown in FIG. 1, the headrest supports 26 include a pair of shaft components 26A that extend in the seat width direction, and the shaft components 26A are supported via ratchet mechanisms (not shown in the drawings) by bearing components (not shown in the drawings) provided in the seatback 18 so as to be pivotable about an axis in the seat width direction.

It will be noted that the height of the headrest stays 24 relative to the headrest supports 26—that is, the position of the headrest stays 24 in their extension direction relative to the headrest supports 26—can be adjusted in stages by manual operation.

Because the headrest 20 is supported via the headrest supports 26 by the seatback 18 as described above, the headrest 20 can take a first state (see FIG. 3A), in which it can support the head of the occupant P sitting in the seat 10 in the seat mode, and a second state (see FIG. 3C), in which it can support the head of the occupant P lying on the support surface 18C of the seatback 18 of the seat 10 in the flat mode.

It will be noted that in the seatback 18 are formed recessed portions 28 in which parts of the headrest stays 24 and the headrest supports 26 fit so as to not obstruct the pivoting of the headrest 20.

Furthermore, in the second mode that is the flat mode of the seatback 18, the headrest 20 is disposed such that it lies on top of the seat front part of the support surface 18C of the seatback 18 as viewed from the seat up and down direction (see FIG. 4).

Moreover, as shown in FIGS. 3B and 3C, the headrest 20 is configured to pivot relative to the seatback 18 such that a surface 20B that is at the seat upper side of the headrest 20 in the first mode that is the seat mode of the seatback 18 is at the seat upper side in the flat mode (the second mode). The surface 20B of the headrest 20 is formed in a shape suitable for supporting the head of the occupant P lying on the seatback 18 of the seat 10 in the flat mode. It will be noted that the headrest 20 is formed in a shape suitable for a surface 20C that is on the seat front side in the seat mode (the first mode) of the seatback 18 to support the head of the occupant P sitting in the seat 10.

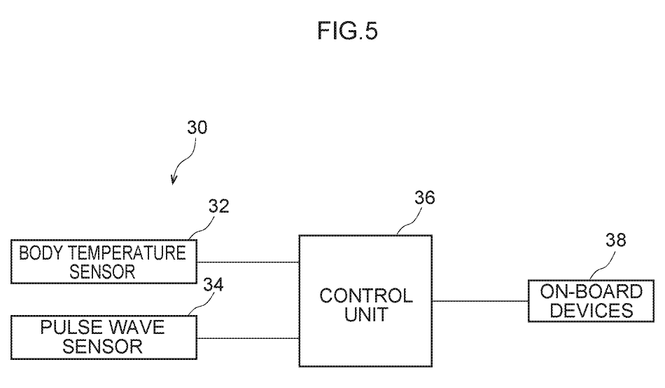

In addition, as shown in FIG. 2B, a part of the headrest 20 on the surface 20B side is provided with a sleep state detection sensor 30. As shown also in FIG. 5, the sleep state detection sensor 30 includes a body temperature sensor 32 that can measure the body temperature of the occupant P and a pulse wave sensor 34 that can measure the pulse waves of the occupant P.

Measurement results of the sleep state detection sensor 30 are sent to a control unit 36, and the control unit 36 can determine whether the occupant P is sleeping by comparing the measurement results of the sleep state detection sensor 30 with various types of data at times when the occupant P is awake.

Furthermore, when the control unit 36 determines that the occupant P is sleeping, the control unit 36 can control various types of on-board devices 38, such as an air conditioning system, to adjust the environment in the cabin 14 to an environment suitable for the occupant P to sleep.

### Action and Effects of This Embodiment

Next, the action and effects of this embodiment will be described.

In this embodiment, as shown in FIG. 1, the seatback 18 is supported such that it can be tilted down toward a seat front side relative to the seat cushion 16. For this reason, as shown also in FIG. 3A, in a state in which the seatback 18 is upright relative to the seat cushion 16, the buttocks of the seated occupant P can be supported by the seat cushion 16 and the back of the occupant P can be supported by the seatback 18.

As shown in FIG. 3B, in a state in which the seatback 18 is tilted down toward a seat front side relative to the seat cushion 16, the occupant P lying on the seatback 18 can be supported by the support surface 18C at the seat upper side of the seatback 18.

Here, in this embodiment, the headrest 20 can take the first state, in which it is disposed at the seat upper side of the seatback 18 in a state in which the seatback 18 is upright relative to the seat cushion 16 as shown in FIG. 3A, and the second state, in which it is disposed at the seat front part of the support surface 18C at the seat upper side of the seatback 18 in a state in which the seatback 18 is tilted down toward a seat front side as shown in FIG. 3C.

For this reason, in the first state, the headrest 20 can support the head of the seated occupant P. Furthermore, in the second state, the headrest 20 can support the head of the occupant P lying on the support surface 18C of the seatback 18. In other words, in this embodiment, the headrest 20 in the second state can be utilized as a pillow for the occupant P lying on the seatback 18.

Furthermore, as mentioned above, in this embodiment, the position of the headrest stays 24 relative to the headrest supports 26 can be adjusted in stages, so in the second state, the position of the headrest 20 can be adjusted in the seat up and down direction. It will be noted that the same also holds true in a third embodiment and a fourth embodiment described below.

Furthermore, in this embodiment, the headrest stays 24 extend from the headrest 20. The seatback 18 is provided with the headrest supports 26 that support the headrest stays 24, and the headrest supports 26 are supported pivotable about an axis in the seat width direction relative to the seatback 18.

For this reason, in this embodiment, the headrest 20 can be switched between the first state and the second state by pivoting the headrest supports 26 relative to the seatback 18.

Furthermore, in this embodiment, the surface 20B that is at the seat upper side in the first state of the headrest 20 is at the seat upper side in the second state of the headrest 20. For this reason, the surfaces that support the head of the occupant P in the first state and the second state of the headrest 20 can be made different.

As a result, the surface 20C that supports the head of the occupant P in the first state of the headrest 20 can be given a shape suitable for supporting the head of the seated occupant P, and the surface 20B that supports the head of the occupant P in the second state of the headrest 20 can be given a shape suitable for supporting the head of the occupant P lying on the seatback 18.

Furthermore, in this embodiment, the sleep state detection sensor 30 is provided at the surface 20B that supports the head of the occupant P in the second state of the headrest 20, and the sleep state of the occupant P lying on the seatback 18 can be detected.

### Second Embodiment

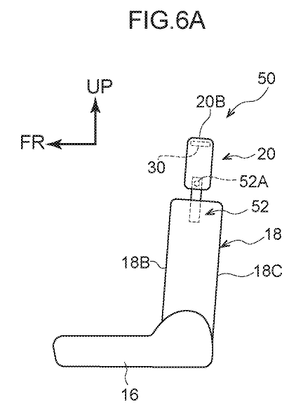

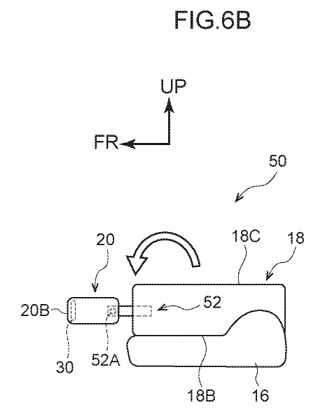

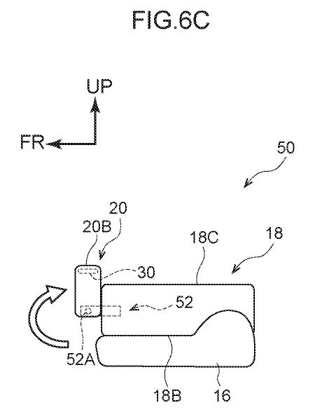

A second embodiment of the vehicle seat pertaining to this disclosure will be described below using FIGS. 6A-6C. It will be noted that constituent parts identical to those of the first embodiment will be assigned identical numbers and description thereof will be omitted.

A vehicle seat 50 (hereinafter called “the seat 50”) pertaining to this embodiment has basically the same configuration as the seat 10, but the configuration of headrest stays 52 are different from those of the seat 10.

Specifically, the headrest stays 52 are disposed as a pair spaced apart from each other in the seat width direction and extend in the seat upward direction from the seatback 18 in the seat mode of the seat 50.

Furthermore, as shown in FIG. 6A, seat upper parts of the headrest stays 52 are provided with a pair of shaft components 52A that extend in the seat width direction. The shaft components 52A are coupled via ratchet mechanisms (not shown in the drawings) to bearing components (not shown in the drawings) provided in the headrest 20 so as to be pivotable about an axis in the seat width direction.

In the seat 50 configured as described above, as shown in FIGS. 6B and 6C, in a state in which the seatback 18 is forwardly tilted down, the headrest 20 is configured to pivot relative to the headrest stays 52 such that the surface 20B that is at the seat upper side of the headrest 20 in the first state is at the seat upper side in the second state. It will be noted that in this embodiment, in the flat mode of the seat 50, the headrest 20 is positioned on the seat front side of the seatback 18.

According to this configuration, the headrest 20 in the second state can be utilized as a pillow for the occupant P lying on the seatback 18, so basically the same action and effects as those of the first embodiment are achieved.

Furthermore, in this embodiment, the headrest stays 52 extend from the seatback 18, and the headrest 20 is supported pivotably about an axis in the seat width direction relative to the headrest stays 52.

For this reason, in this embodiment, the headrest 20 can be switched between the first state and the second state by pivoting the headrest 20 relative to the headrest stays 52.

### Third Embodiment

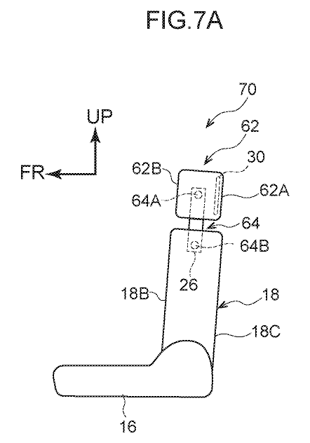

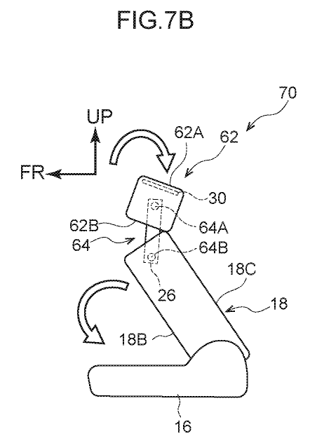

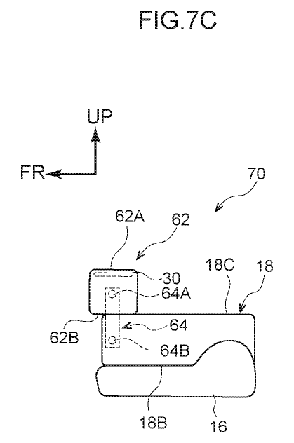

A third embodiment of the vehicle seat pertaining to this disclosure will be described below using FIGS. 7A to 7C. It will be noted that constituent parts identical to those of the first embodiment will be assigned identical numbers and description thereof will be omitted.

A vehicle seat 60 (hereinafter called “the seat 60”) pertaining to this embodiment has basically the same configuration as the seat 10 of the first embodiment, but the configurations of a headrest 62 and headrest stays 64 are different from those of the seat 10.

Specifically, the headrest 62 has basically the same configuration as the headrest 20 of the second embodiment, but as shown in FIGS. 7A to 7C, a surface 62A that is at the seat rear side of the headrest 62 in the seat mode of the seat 60 is formed in a shape suitable for supporting the head of the occupant P lying on the seatback 18 in the flat mode of the seat 60. Furthermore, a part of the headrest 62 on the surface 62A side is, like the part of the headrest 20 on the surface 20B side in the second embodiment, provided with the sleep state detection sensor 30.

It will be noted that a surface 62B that is on the seat front side in the first state of the headrest 62 is formed in a shape suitable for supporting the head of the occupant P sitting in the seat 60.

The headrest stays 64 have, on parts of one end portion sides thereof, a pair of shaft components 64A that extend in the seat width direction. The shaft components 64A are coupled via ratchet mechanisms (not shown in the drawings) to bearing components (not shown in the drawings) provided in the headrest 62 so as to be pivotable about an axis in the seat width direction.

Part of other end portion sides of the headrest stays 64 are, like the headrest stays 24 of the first embodiment, supported by the headrest supports 26.

In the seat 60 configured as described above, as shown in FIGS. 7B and 7C, in a state in which the seatback 18 is forwardly tilted down, the headrest 62 is configured to pivot relative to the seatback 18 such that the surface 62A that is at the seat rear side of the headrest 62 in the first state is at the seat upper side in the second state. It will be noted that in this embodiment, in the flat mode of the seat 60, the headrest 62 is positioned at the seat upper side of the seatback 18 as in the seat 10 of the first embodiment.

According to this configuration, the headrest 62 in the second state can be utilized as a pillow for the occupant P lying on the seatback 18, so basically the same action and effects as those of the first embodiment are achieved.

Furthermore, in this embodiment, the headrest 62 pivots about an axis in the seat width direction relative to the headrest stays 64, and the surface 62A that is at the seat rear side in the first state of the headrest 62 is at the seat upper side in the second state of the headrest 62. For this reason, the surfaces that support the head of the occupant P in the first state of the headrest 62 and the second state of the headrest 62 can be made different.

As a result, the surface 62B that supports the head of the occupant P in the first state of the headrest 62 can be given a shape suitable for supporting the head of the seated occupant P, and the surface 62A that supports the head of the occupant P in the second state of the headrest 62 can be given a shape suitable for supporting the head of the occupant P lying on the seatback 18.

Furthermore, compared with a configuration where the surface 62A that supports the head of the occupant P in the second state of the headrest 62 is positioned at the seat upper side in the first state of the headrest 62, the headrest 62 can be inhibited from increasing in size, and areas for the surfaces that support the head of the occupant P in the first state of the headrest 62 and the second state of the headrest 62 can be ensured.

Moreover, in this embodiment, the sleep state detection sensor 30 is provided at the surface 62A that supports the head of the occupant P in the second state of the headrest 62, and the sleep state of the occupant P lying on the seatback 18 can be detected.

### Example Modification of Third Embodiment

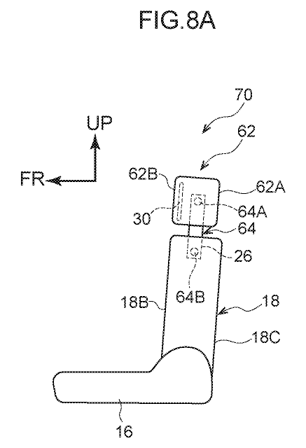

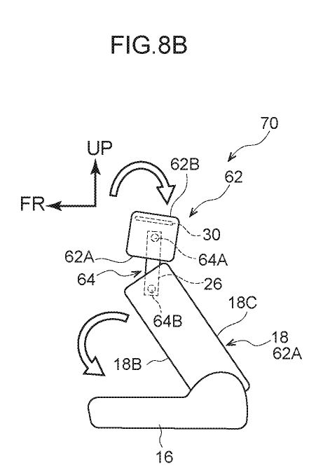

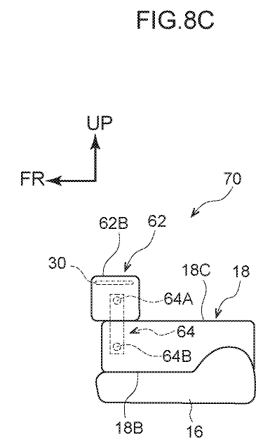

An example modification of the third embodiment of the vehicle seat pertaining to this disclosure will be described below using FIGS. 8A to 8C.

In this example modification, as shown in FIGS. 8A to 8C, the surface 62B that is on the seat front side in the first state of the headrest 62 is configured to be at the seat upper side in the second state of the headrest 62. That is, the head of the occupant P is supported by the surface 62B in the first state of the headrest 62 and the second state of the headrest 62.

Furthermore, in this example modification, the sleep state detection sensor 30 is provided in a part of the headrest 62 on the surface 62B side.

According to this configuration, the sleep state of the occupant P can be detected when the occupant P is sitting and when the occupant P is lying on the seatback 18.

### Fourth Embodiment

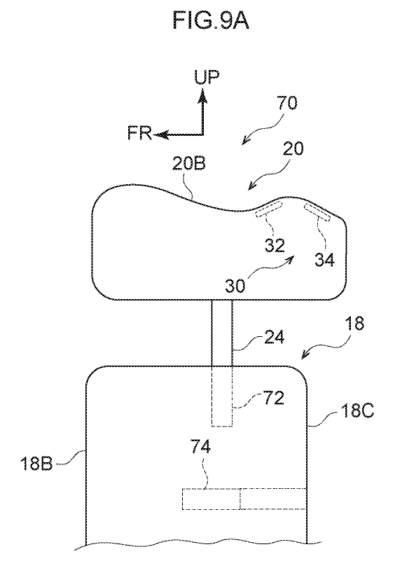

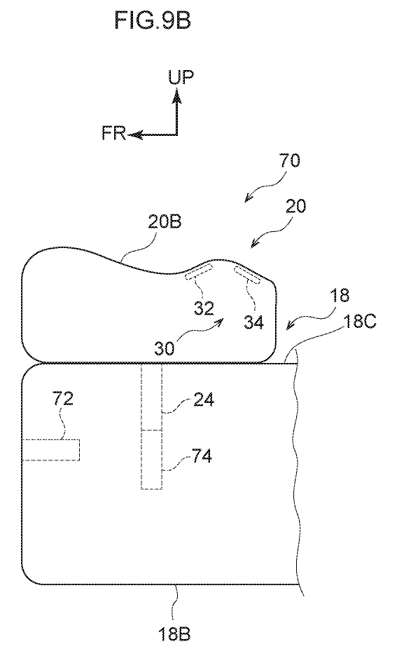

A fourth embodiment of the vehicle seat pertaining to this disclosure will be described below using FIGS. 9A to 9C. It will be noted that constituent parts identical to those of the first embodiment will be assigned identical numbers and description thereof will be omitted.

A vehicle seat 70 (hereinafter called “the seat 70”) pertaining to this embodiment has basically the same configuration as the seat 10 of the first embodiment but differs from the seat 10 in that it has first headrest supports 72 and second headrest supports 74 instead of the headrest supports 26.

Specifically, as shown in FIG. 9A, the first headrest supports 72 are disposed as a pair spaced apart from each other in the seat width direction in a part of the seatback 18 that is at the seat upper seat in the seat mode of the seat 70. Furthermore, the first headrest supports 72 are secured to the seatback 18 such that the insertion direction of the headrest stays 24 coincides with the seat up and down direction in the seat mode of the seat 70.

The second headrest supports 74 are disposed as a pair spaced apart from each other in the seat width direction in a part of the seatback 18 that is on the seat front side in the flat mode of the seat 70. Furthermore, the second headrest supports 74 are secured to the seatback 18 such that the insertion direction of the headrest stays 24 coincides with the seat up and down direction in the flat mode of the seat 70.

In this embodiment, inserting the headrest stays 24 into the first headrest supports 72 in the seat 70 in the seat mode puts the headrest 20 in the first state in which it can support the head of the seated occupant P. Furthermore, inserting the headrest stays 24 into the second headrest supports 74 in the seat 70 in the flat mode puts the headrest 20 in the second state in which it can support the head of the occupant P lying on the support surface 18C of the seatback 18.

According to this configuration, the headrest 20 in the second state can be utilized as a pillow for the occupant P lying on the seatback 18, so basically the same action and effects as those of the first embodiment are achieved.

Furthermore, in this embodiment, the positions of the first headrest supports 72 and the second headrest supports 74 can be individually set, and flexibility for the set position of the headrest 20 in the first state and the set position of the headrest 20 in the second state can be ensured.

As described above, in the seat 10 pertaining to the first embodiment, the seat 50 pertaining to the second embodiment, the seat 60 pertaining to the third embodiment, and the seat 70 pertaining to the fourth embodiment, the sleeping environment of the occupant P can be improved on the support surface 18C of the seatback 18.

What is claimed is:

1. A vehicle seat, comprising:
a seat cushion that is configured to support the buttocks of a seated occupant;
a seatback that is supported tiltably downward toward a seat front side relative to the seat cushion; and
a headrest configured to adopt a first state, in which the headrest is disposed at a seat upper side of the seatback and is configured to support the head of the seated occupant in a state in which the seatback is upright relative to the seat cushion, and a second state, in which the headrest is disposed at a portion at a seat front side of a support surface at the seat upper side of the seatback and the headrest is configured to support the head of the occupant lying on the support surface in a state in which the seatback is tilted downward toward the seat front side.

2. The vehicle seat of claim 1, wherein:
a headrest stay extends from the headrest, and
the seatback is provided with a first headrest support that supports the headrest stay in the first state and a second headrest support that supports the headrest stay in the second state.

3. The vehicle seat of claim 1, wherein:
a headrest stay extends from the headrest, and
the seatback includes a headrest support that supports the headrest stay and the headset support is supported pivotably about an axis in a seat width direction relative to the seatback.

4. The vehicle seat of claim 1, wherein:
a headrest stay configured to support the headrest extends from the seatback, and
the headrest is supported pivotably about an axis in a seat width direction relative to the headrest stay.

5. The vehicle seat of claim 2, wherein:
the headrest is displaceable relative to the seatback such that a surface of the headrest that is at the seat upper side in the first state is at the seat upper side in the second state, and
a sleep state detection sensor configured to detect a sleep state of the occupant is provided at the surface of the headrest.

6. The vehicle seat of claim 3, wherein:
the headrest is displaceable relative to the seatback such that a surface of the headrest that is at the seat upper side in the first state is at the seat upper side in the second state, and
a sleep state detection sensor configured to detect a sleep state of the occupant is provided at the surface of the headrest.

7. The vehicle seat of claim 4, wherein:
the headrest is displaceable relative to the seatback such that a surface of the headrest that is at the seat upper side in the first state is at the seat upper side in the second state, and
a sleep state detection sensor configured to detect a sleep state of the occupant is provided at the surface of the headrest.

8. The vehicle seat of claim 3, wherein:
the headrest is supported pivotably about an axis in the seat width direction relative to the headrest stay such that a surface of the headrest that is at a seat rear side in the first state is at the seat upper side in the second state, and
a sleep state detection sensor configured to detect a sleep state of the occupant is provided at the surface of the headrest.

9. The vehicle seat of claim 3, wherein:
the headrest is supported pivotably about an axis in the seat width direction relative to the headrest stay such that a surface of the headrest that is at the seat front side in the first state is at the seat upper side in the second state, and
a sleep state detection sensor configured to detect a sleep state of the occupant is provided at the surface of the headrest.
